(19) United States
(12) Patent Application Publication
(10) Pub. No.: US 2005/0283756 A1
(43) Pub. Date: Dec. 22, 2005

(54) Method and system to automatically generate performance evaluation code for multi-threaded/multi-processor architectures

(75) Inventor: T.J. O'Dwyer, Tipperary (IE)

Correspondence Address: Daly, Crowley & Mofford, LLP;PortfolioIP, P.O. Box 52050, Minneapolis, MN, 55402, US

(73) Assignee: Intel Corporation

(21) Appl. No.: 10/874,098

(22) Filed: Jun. 22, 2004

(51) Int. Cl. G06F 9/44

(52) U.S. Cl. 717/109

(57) ABSTRACT

A development system automatically generates evaluation code to examine performance on target hardware.

### CROSS REFERENCE TO RELATED APPLICATIONS

Not Applicable.

### STATEMENT REGARDING FEDERALLY SPONSORED RESEARCH

Not Applicable.

### BACKGROUND

As is known in the art, developing code for multi-processor, multi-threaded systems such as that of the IXP2XXX Network Processor Product Line from Intel Corporation is quite challenging. Network processors belonging to the IXP2XXX Network Processor Product Line contain multiple processing engines, each with multiple hardware threads to perform multiple tasks, such as packet processing, in parallel. Designing application software for such a system can be relatively complex.

To aid development, architecture visualization tools, such as the Intel IXP2XXX Product Line Architecture Tool, can be used to describe and analyze the application prior to writing any code. Further development can progress using development tools, such as the Intel IXA SDK Workbench, to write and test code for the target processor.

While such tools are useful, they may provide limited performance evaluation information for actual target hardware. That is, a developer may not have a good sense of whether the various tasks can be performed to meet various performance requirements.

### BRIEF DESCRIPTION OF THE DRAWINGS

The exemplary embodiments will be more fully understood from the following detailed description taken in conjunction with the accompanying drawings, in which:

FIG. 1 is a block diagram of a processor having processing elements that support multiple threads of execution;

FIG. 2 is a block diagram of an exemplary processing element (PE) that runs microcode;

FIG. 3 is a depiction of some local Control and Status Registers (CSRs) of the PE of FIG. 2;

FIG. 4 is a diagram showing pipeline drawings, task drawings and performance evaluations for an architecture development tool;

FIG. 5 is a graphical representation showing an exemplary task;

FIG. 5A is an exemplary graphical user interface to define a code block;

FIG. 5B is an exemplary graphical user interface to define an I/O reference;

FIG. 6 is a graphical representation of an application pipeline;

FIG. 7 is a schematic depiction of an exemplary development/debugging system that can be used to automatically generally evaluation microcode for the PE shown in FIG. 2;

FIG. 8 is a block diagram illustrating the various components of the development/debugger system of FIG. 7;

FIG. 9 is a code listing for an exemplary task segment;

FIG. 10 is a code listing for another exemplary task segment;

FIGS. 11A and 11B together show an exemplary code listing for the task of FIG. 5;

FIG. 12 is a code listing of a dispatch loop for a context pipeline;

FIG. 12A is a code listing of a dispatch loop for a functional pipeline;

FIG. 13 is a flow diagram showing exemplary process blocks implementing automatic generation of evaluation code;

FIG. 14 is a schematic representation of an exemplary computer system suited to run an application automatically generating evaluation code for one or more processing elements; and

FIG. 15 is a diagram of a network forwarding device.

### DETAILED DESCRIPTION

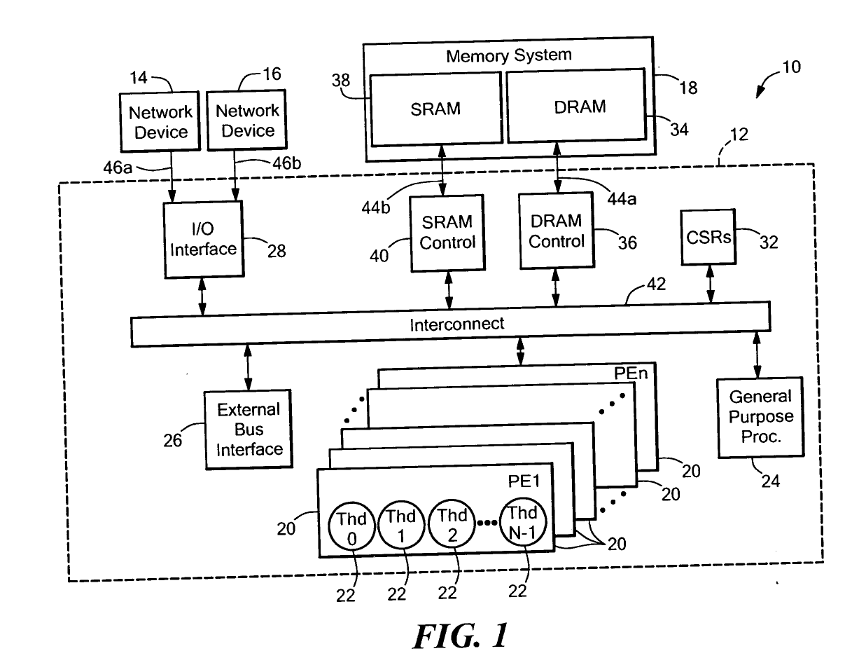

FIG. 1 shows a system 10 including a processor 12 for which code can be automatically generated to evaluate performance characteristics. The processor 12 is coupled to one or more I/O devices, for example, network devices 14 and 16, as well as a memory system 18. The processor 12 includes multiple processors (“processing engines” or “PEs”) 20, each with multiple hardware controlled execution threads 22. In the example shown, there are “n” processing elements 20, and each of the processing elements 20 is capable of processing multiple threads 22, as will be described more fully below. In the described embodiment, the maximum number “N” of threads supported by the hardware is eight. Each of the processing elements 20 is connected to and can communicate with adjacent processing elements.

In one embodiment, the processor 12 also includes a general-purpose processor 24 that assists in loading microcode control for the processing elements 20 and other resources of the processor 12, and performs other computer type functions such as handling protocols and exceptions. In network processing applications, the processor 24 can also provide support for higher layer network processing tasks that cannot be handled by the processing elements 20.

The processing elements 20 each operate with shared resources including, for example, the memory system 18, an external bus interface 26, an I/O interface 28 and Control and Status Registers (CSRs) 32. The I/O interface 28 is responsible for controlling and interfacing the processor 12 to the I/O devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, storing buffer descriptors and free buffer lists, and so forth.

The devices 14, 16 can be any network devices capable of transmitting and/or receiving network traffic data, such as framing/MAC devices, e.g., for connecting to 10/100BaseT Ethernet, Gigabit Ethernet, ATM or other types of networks, or devices for connecting to a switch fabric. For example, in one arrangement, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The I/O interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The I/O interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also serviced by the processor 12.

In general, as a network processor, the processor 12 can interface to various types of communication devices or interfaces that receive/send data. The processor 12 functioning as a network processor could receive units of information from a network device like network device 14 and process those units in a parallel manner. The unit of information could include an entire network packet (e.g., Ethernet packet) or a portion of such a packet, e.g., a cell such as a Common Switch Interface (or “CSIX”) cell or ATM cell, or packet segment. Other units are contemplated as well.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The I/O Interface 28 is coupled to the devices 14 and 16 via separate I/O bus lines 46a and 46b, respectively.

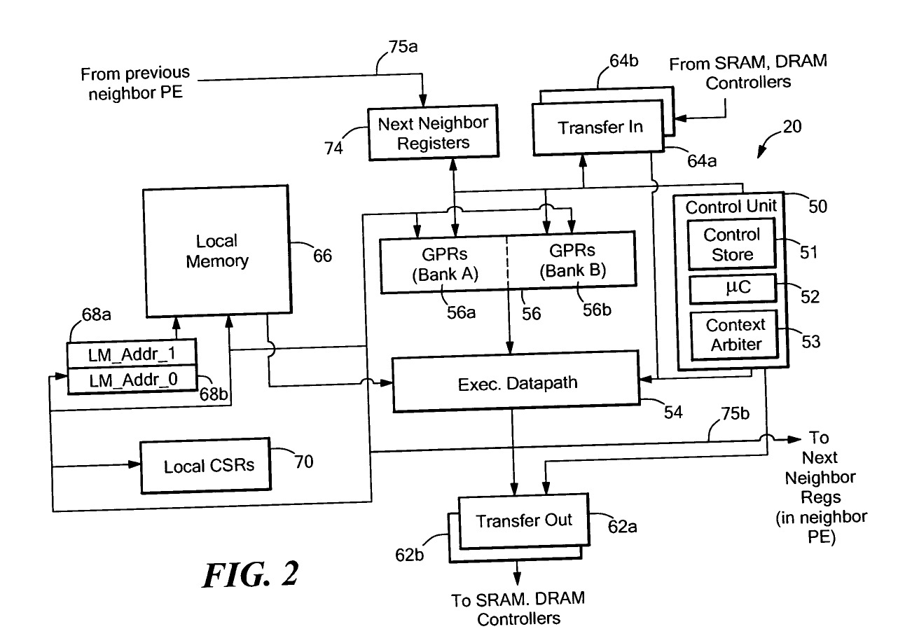

Referring to FIG. 2, an exemplary one of the processing elements 20 is shown. The processing element (PE) 20 includes a control unit 50 that includes a control store 51, control logic (or microcontroller) 52 and a context arbiter/event logic 53. The control store 51 is used to store microcode. The microcode is loadable by the processor 24. The functionality of the PE threads 22 is therefore determined by the microcode loaded via the core processor 24 for a particular user's application into the processing element's control store 51.

The microcontroller 52 includes an instruction decoder and program counter (PC) unit for each of the supported threads. The context arbiter/event logic 53 can receive messages from any of the shared resources, e.g., SRAM 38, DRAM 34, or processor core 24, and so forth. These messages provide information on whether a requested function has been completed.

The PE 20 also includes an execution datapath 54 and a general purpose register (GPR) file unit 56 that is coupled to the control unit 50. The datapath 54 may include a number of different datapath elements, e.g., an ALU, a multiplier and a Content Addressable Memory (CAM).

The registers of the GPR file unit 56 (GPRs) are provided in two separate banks, bank A 56a and bank B 56b. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The PE 20 further includes write transfer (transfer out) register file 62 and a read transfer (transfer in) register file 64. The write transfer registers of the write transfer register file 62 store data to be written to a resource external to the processing element. In the illustrated embodiment, the write transfer register file is partitioned into separate register files for SRAM (SRAM write transfer registers 62a) and DRAM (DRAM write transfer registers 62b). The read transfer register file 64 is used for storing return data from a resource external to the processing element 20. Like the write transfer register file, the read transfer register file is divided into separate register files for SRAM and DRAM, register files 64a and 64b, respectively. The transfer register files 62, 64 are connected to the datapath 54, as well as the control store 50. It should be noted that the architecture of the processor 12 supports “reflector” instructions that allow any PE to access the transfer registers of any other PE.

Also included in the PE 20 is a local memory 66. The local memory 66 is addressed by registers 68a (“LM_Addr_{—}1”), 68b (“LM_Addr_{—}0”), which supplies operands to the datapath 54, and receives results from the datapath 54 as a destination.

The PE 20 also includes local control and status registers (CSRs) 70, coupled to the transfer registers, for storing local inter-thread and global event signaling information, as well as other control and status information. Other storage and functions units, for example, a Cyclic Redundancy Check (CRC) unit (not shown), may be included in the processing element as well.

Other register types of the PE 20 include next neighbor (NN) registers 74, coupled to the control store 50 and the execution datapath 54, for storing information received from a previous neighbor PE (“upstream PE”) in pipeline processing over a next neighbor input signal 76a, or from the same PE, as controlled by information in the local CSRs 70. A next neighbor output signal 76b to a next neighbor PE (“downstream PE”) in a processing pipeline can be provided under the control of the local CSRs 70. Thus, a thread on any PE can signal a thread on the next PE via the next neighbor signaling.

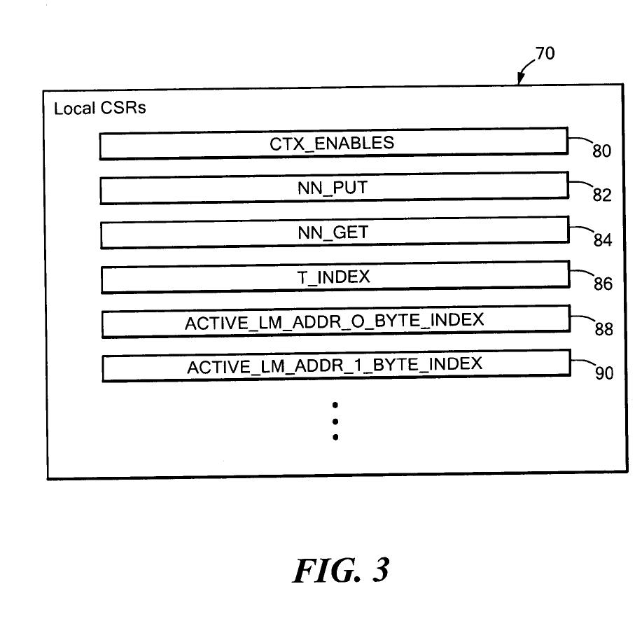

Generally, the local CSRs 70 are used to maintain context state information and inter-thread signaling information. Referring to FIG. 3, registers in the local CSRs 70 may include the following: CTX_ENABLES 80; NN_PUT 82; NN_GET 84; T_INDEX 86; ACTIVE_LM ADDR_{—}0_BYTE_INDEX 88; and ACTIVE_LM ADDR_{—}1_BYTE_INDEX 90. The CTX_ENABLES register 80 specifies, among other information, the number of contexts in use (which determines GPR and transfer register allocation) and which contexts are enabled. It also controls how NN mode, that is, how the NN registers in the PE are written (NN_MODE=‘0’ meaning that the NN registers are written by a previous neighbor PE, NN_MODE=1′ meaning the NN registers are written from the current PE to itself). The NN_PUT register 82 contains the “put” pointer used to specify the register number of the NN register that is written using indexing. The NN_GET register 84 contains the “get” pointer used to specify the register number of the NN register that is read when using indexing. The T_INDEX register 86 provides a pointer to the register number of the transfer register (that is, the S_TRANSFER register 62a or D_TRANSFER register 62b) that is accessed via indexed mode, which is specified in the source and destination fields of the instruction. The ACTIVE_LM ADDR_{—}0_BYTE_INDEX 88 and ACTIVE_LM ADDR_{—}1_BYTE_INDEX 90 provide pointers to the number of the location in local memory that is read or written. Reading and writing the ACTIVE_LM_ADDR_x_BYTE_INDEX register reads and writes both the corresponding LM_ADDR_x register and BYTE INDEX registers (also in the local CSRs).

In the illustrated embodiment, the GPR, transfer and NN registers are provided in banks of 128 registers. The hardware allocates an equal portion of the total register set to each PE thread. The 256 GPRs per-PE can be accessed in thread-local (relative) or absolute mode. In relative mode, each thread accesses a unique set of GPRs (e.g., a set of 16 registers in each bank if the PE is configured for 8 threads). In absolute mode, a GPR is accessible by any thread on the PE. The mode that is used is determined at compile (or assembly) time by the programmer. The transfer registers, like the GPRs, can be assessed in relative mode or in absolute-mode. If accessed globally in absolute mode, they are accessed indirectly through an index register, the T_INDEX register. The T_INDEX is loaded with the transfer register number to access.

As discussed earlier, the NN registers can be used in one or two modes, the “neighbor” and “self” modes (configured using the NN_MODE bit in the CTX_ENABLES CSR). The “neighbor” mode makes data written to the NN registers available in the NN registers of a next (adjacent) downstream PE. In the “self” mode, the NN registers are used as extra GPRs. That is, data written into the NN registers is read back by the same PE. The NN_GET and NN_PUT registers allow the code to treat the NN registers as a queue when they are configured in the “neighbor” mode. The NN_GET and NN_PUT CSRs can be used as the consumer and producer indexes or pointers into the array of NN registers.

At any give time, each of the threads (or contexts) of a given PE is in one of four states: inactive; executing; ready and sleep. At most one thread can be in the executing state at a time. A thread on a multi-threaded processor such as PE 20 can issue an instruction and then swap out, allowing another thread within the same PE to run. While one thread is waiting for data, or some operation to complete, another thread is allowed to run and complete useful work. When the instruction is complete, the thread that issued it is signaled, which causes that thread to be put in the ready state when it receives the signal. Context switching occurs only when an executing thread explicitly gives up control. The thread that has transitioned to the sleep state after executing and is waiting for a signal is, for all practical purposes, temporarily disabled (for arbitration) until the signal is received.

While illustrative target hardware is shown and described herein in some detail, it is understood that the exemplary embodiments shown and described herein for automatically generating code for performance evaluation are applicable to a variety of hardware, processors, architectures, devices, development systems/tools and the like.

In an exemplary embodiment, an architecture development tool is used to generate a visual diagram of an application. Based upon the diagram, a code development system can automatically generate evaluation code to examine performance for the application, e.g., packet processing. More particularly, the automatically generated code can be used to determine whether performance requirements will be met by a processor system, such as the processor 12 of FIG. 1. In general, the automatically generated code is not intended to implement a particular function, but rather to simulate instruction execution times and input/output (I/O) operations.

Since much of the information about the application, such as packet processing, is described in the architecture tool, this information can be used to generate evaluation code. Developers can generate functional code to fill in gaps and replace the automatically generated code as necessary. With this arrangement, the overall code development process is accelerated. In addition, the level of confidence that budgeted performance levels will be met is increased.

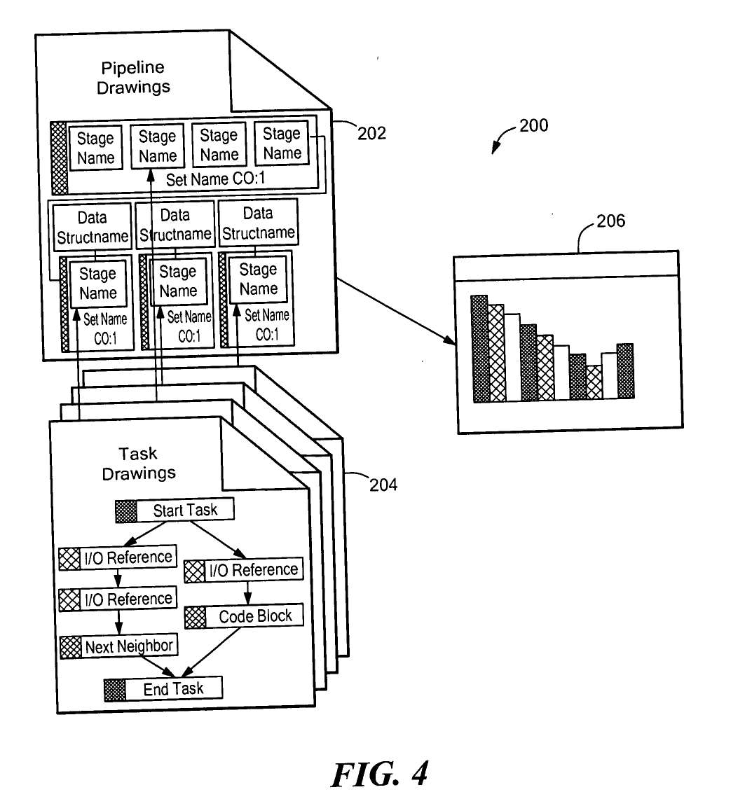

FIG. 4 shows an overview of an exemplary visualized project 200 generated by application architecture development tool for target hardware, such as the system 12 of FIG. 1. The architecture tool guides the user through the project design process and provides the user with an estimate of network processor performance. The resulting documentation describing the system generated by architecture tool can be used by a development/debug system to enable software developers to generate code to implementing the design. In general, designing a project requires knowledge of the processing activities as well as the data structures that are referenced as the packets flow through the processor.

The processing requirements are divided into separate tasks that are assigned to pipe stages that are then mapped onto processing elements. Tasks are described by the following:
I/O References: Determine the loading imposed on the internal buses and external memory buses. I/O References are also used to determine the task execution time.
Next Neighbor communications: A next neighbor relationship is defined because they impose a requirement on the physical location of the PEs that the tasks are assigned to.
Code Blocks: Code blocks are used to determine the task execution time and PE utilization.
   A project is defined at a high level requiring knowledge of the processing requirements of the application being analyzed. Basic components of the project include visual representations of pipelines 202 and tasks 204 from which performance analysis information 206 can be obtained.

A pipeline drawing 202 provides a description of the pipeline and the mapping of the pipeline onto the processor. A task drawing 204 provides a high level description of the work performed in a task. Tasks are assigned to pipe stages. The task description includes the I/O references, next neighbor references, and code blocks. The analysis 206 of the pipeline drawing can provide memory space utilization, internal bus utilization, external memory bus utilization, task execution time, and PE utilization.

In an exemplary embodiment, functional and context pipelines can be modeled. In general, functional pipelines perform multiple tasks in order across one or more threads in one or more processing elements, such as the processing elements 20 of FIGS. 1 and 2. For simplicity, it can be assumed that functional pipelines are allocated to a whole number of processing elements completely, i.e., all the threads of one or more processing elements. Context pipelines perform a single task across multiple threads on the same processing element. A task in this case is a piece of processing logic that executes microcode instructions and possibly performs input/output (I/O) operations with other on-chip functional units.

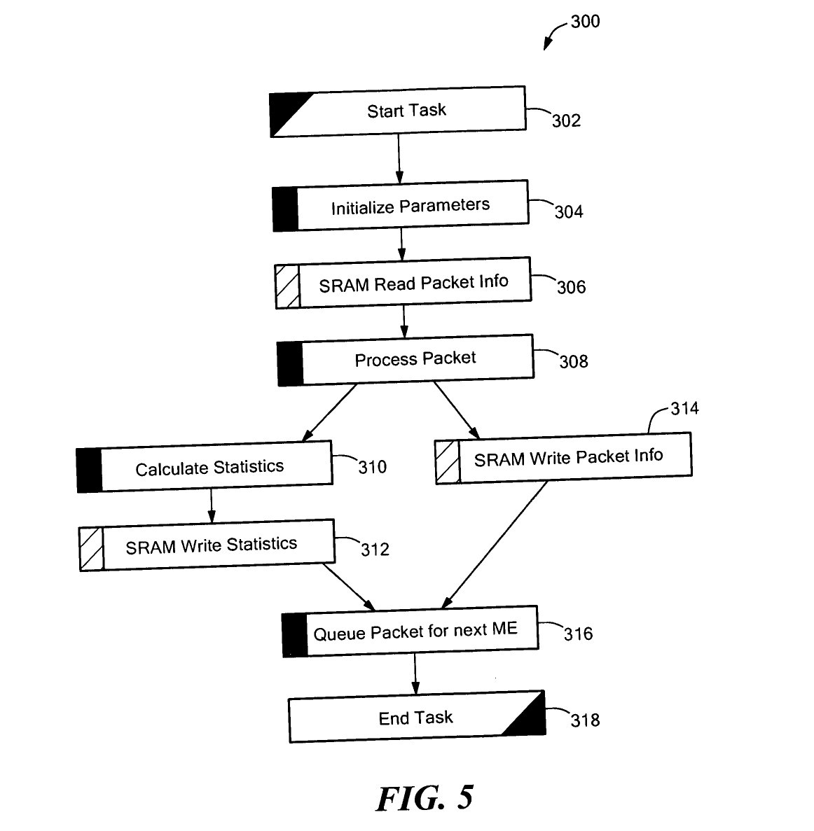

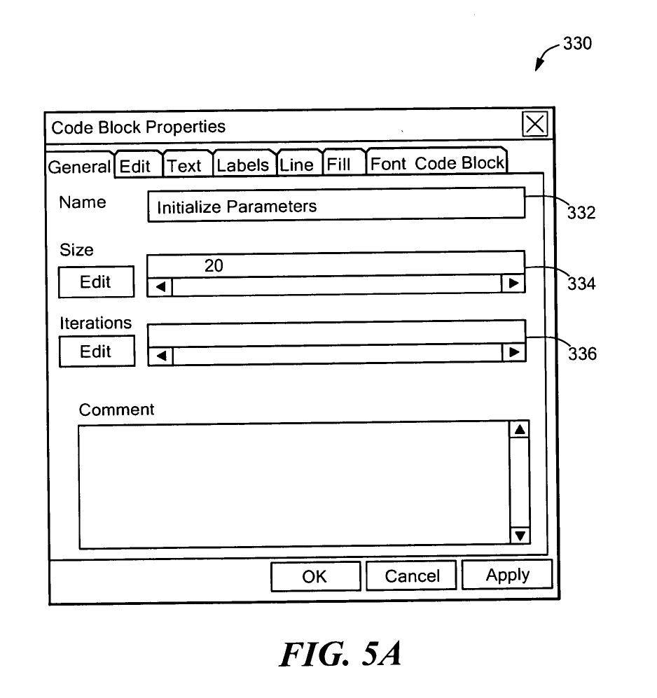

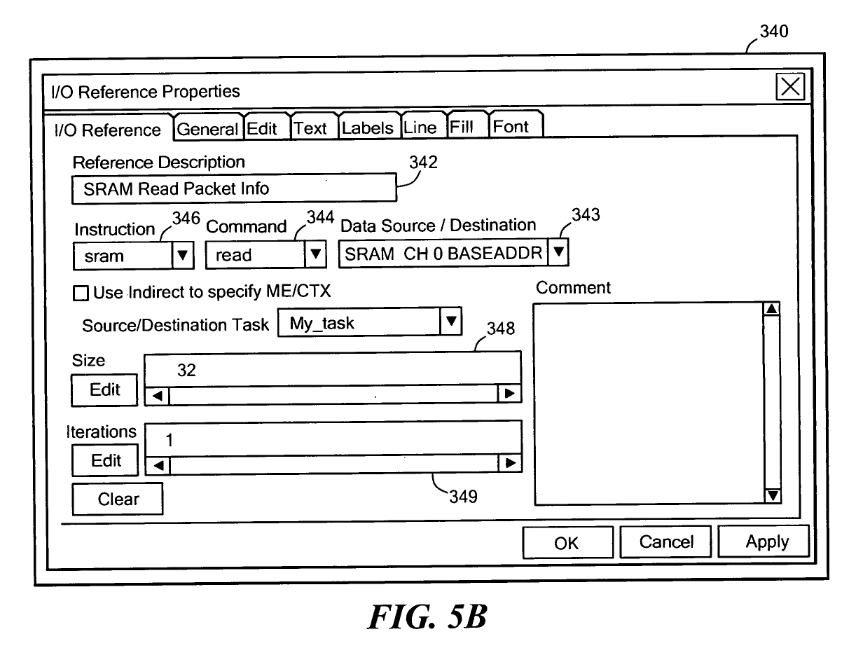

FIG. 5 shows an exemplary task drawing 300 directed to processing packets within a performance budget for given target hardware. The task includes various code blocks, I/O references and next-neighbor references with a start and end point. In the illustrated embodiment, the type (e.g., I/O reference, NN reference, code block) of each task portion is indicated with a respective symbol on the left side of the task segment. Code blocks represent an uninterrupted sequence of instructions executed on a processing element thread. I/O references are operations in which a functional unit external to a processing element is accessed that may require the processing element to halt execution of its code until the operation has completed. A next-neighbor operation references another processing element. Each code block, I/O reference and NN reference has associated attributes such as size, functional unit, operation, etc., described using dialog boxes.

In a first task segment 302, the task is started. Then in a first code block 304, parameters are initialized and in I/O reference block 306 packet information is read from SRAM. In a second code block 308, the packet is processed. From the second code block 308, processing can continue in parallel between a code block 310 to calculate statistics that are written to SRAM in I/O reference block 312 and an I/O reference 314 to write packet info to SRAM. After an I/O instruction, it is common to initiate a context switch and perform some type of processing, here calculating statistics in a code block 310, while waiting for a signal that the I/O operation is complete. In next neighbor (NN) block 316, a packet is queued for the next processing element and in block 318 the task ends.

The task drawing 300 represents the work performed in a pipe stage for a particular data stream. The task drawing identifies I/O references for the task and code blocks performed while processing the packets. As described further below the I/O references, code blocks and NN references can be defined so that evaluation code can be automatically generated to evaluate performance.

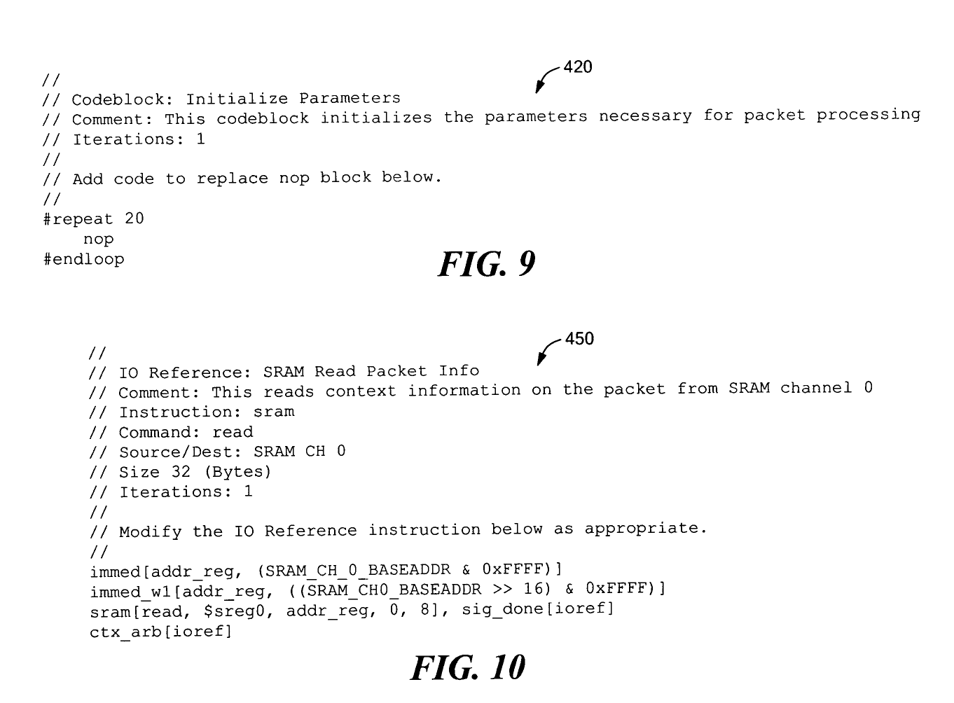

FIG. 5A shows an exemplary graphical user interface (GUI) 330 to enable a user to define a code block, such as the code block 304 of FIG. 5, for which automatically generated code 420 is shown in FIG. 9. Various characteristics, such as size, name etc., for the code block can be specified by the user. The GUI 330 includes a name field 332 into which the user can input a name for the code block, such as “initialize parameters.” The size, e.g., 20 instructions, of the code block can be input in a size field 334. And the number of iterations, e.g., 1, can be provided in an iteration field 336. The number of iterations can be defined as a variable.

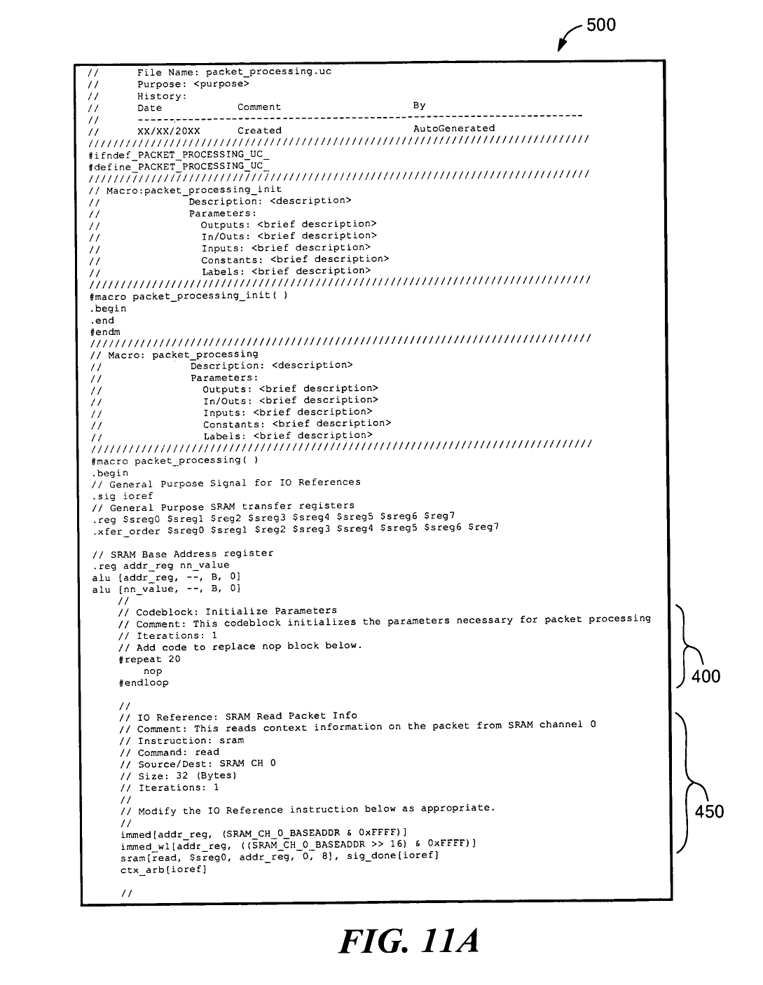

FIG. 5B shows a GUI window 340 to enable a user to define an I/O reference, such as the SRAM Read Packet Info 306 of FIG. 5, for which the code 450 can be automatically generated as shown in FIG. 10. The I/O reference GUI 340 includes a reference description field 342 and a data source/destination field 343, e.g., SARAM_CH_{—}0_BASEADDR. The data source/destination identifies the internal and external data buses affected by the I/O reference. The type of instruction, e.g., read, can be described in an instruction field 344 and a command type, e.g., read, can be defined in a command field 346. The size in bytes, e.g., 32, of the I/O reference can be defined in a size field 348. The number of iterations for the I/O reference can be input by the user in an iterations field 349, which can be conditional.

A NN reference can be defined in a similar manner as the code block and I/O reference.

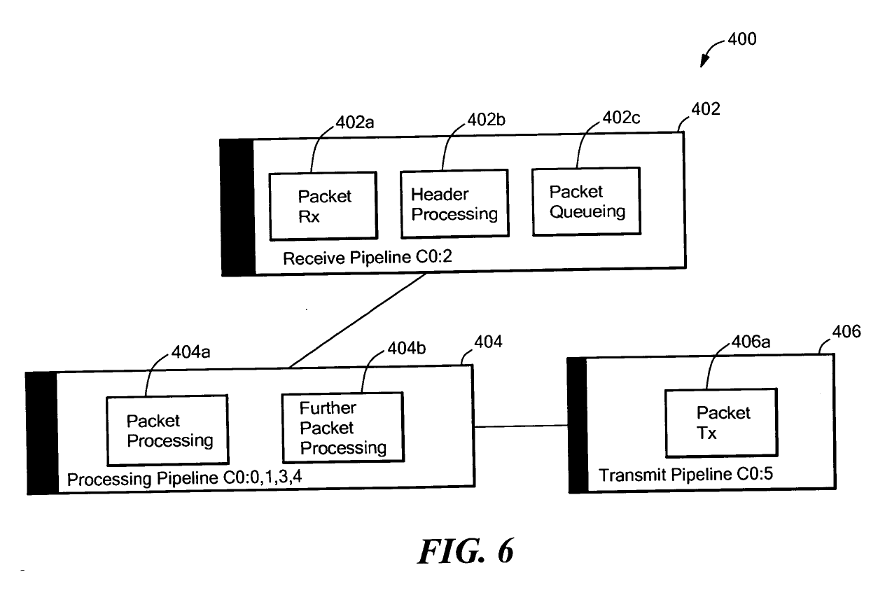

FIG. 6 shows a visual representation 400 of an exemplary packet processing pipeline of which the task 300 of FIG. 5 can form a part. A first dialog box 402 corresponds to a receive pipeline, which is a context pipeline, having a packet receive task 402a, a header processing task 402b, and a packet queuing task 402c. A second dialog box 404 corresponds to a packet processing pipeline, which is a functional pipeline. The packet processing pipeline 404 includes a packet processing task 404a and a further packet processing task 404b. The receive pipeline 402 provides a stream of data to the packet processing pipeline 404. A third dialog box 406 corresponds to a (context) packet transmit pipeline having a packet transmit task 406a.

The pipelines can include a reference to particular processing elements in particular clusters of processing elements. For example, C0:2 in the receive pipeline can refer to cluster 0, processing element 2.

Once the high-level project design is complete using the architecture tool, some performance analysis can be performed as described above in conjunction with FIG. 4. If the performance is acceptable, the project file for the architecture tool can be provided to a software development system, which can have similar features and functionality as the Intel IXA SDK Workbench system. The development system first validates the project file from the architecture tool.

In an exemplary embodiment, the development system can automatically generate evaluation code from the project file of the architecture tool that can be used to examine performance for target hardware. The automatically generate code is not intended to implement a function but rather to execute instructions that should take a similar amount of processing load as the actual code to be developed later. For example, code blocks can have NOP instructions in place of actual instructions, which can be created later by the developer. A repeat loop is used to execute the desired number of NOP instructions that should take the same amount of time to execute as the later-developed code. By using a NOP block, a developer can evaluate code that will behave in a manner similar to the final code from a performance viewpoint, to provide early feasibility/performance testing.

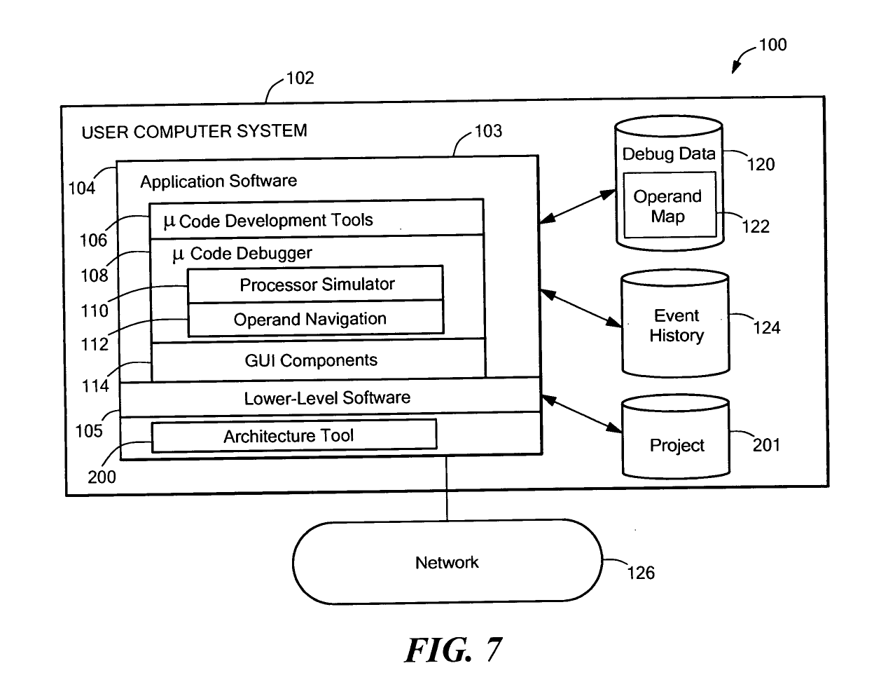

FIG. 7 shows a system environment 100 that can include an architecture development tool, such as the tool 200 of FIG. 4, and a development/debugger tool. The system can automatically generate evaluation code based upon an output from the architecture tool. The system 100 includes a user computer system 102. The computer system 102 enables a user to design an architecture for an application to run on target hardware and to develop/process/debug microcode that is intended to execute on one or more processing elements of the target hardware. In one embodiment, the processing element is the PE 20, which may operate in conjunction with other PEs 20, as shown in FIGS. 1-2.

Software 103 includes both upper-level application software 104 and lower-level software (such as an operating system or “OS”) 105. The application software 104 includes an architecture design tool 200 and microcode development tools 106 (for example, in the example of processor 12, a compiler and/or assembler, and a linker, which takes the compiler or assembler output on a per-PE basis and generates an image file for all specified PEs). The application software 104 further includes a source level microcode debugger 108, which include a processor simulator 110 (to simulate the hardware features of processor 12) and an Operand Navigation mechanism 112. Also include in the application software 104 are GUI components 114, some of which support the Operand Navigation mechanism 112. The Operand Navigation 112 can be used to trace instructions.

Still referring to FIG. 7, the system 102 also includes several databases. The databases include debug data 120, which is “static” (as it is produced by the compiler/linker or assembler/linker at build time) and includes an Operand Map 122, and an event history 124. The event history stores historical information (such as register values at different cycle times) that is generated over time during simulation. The project database 201 contains project pipeline and task design information. The system 102 may be operated in standalone mode or may be coupled to a network 126 (as shown).

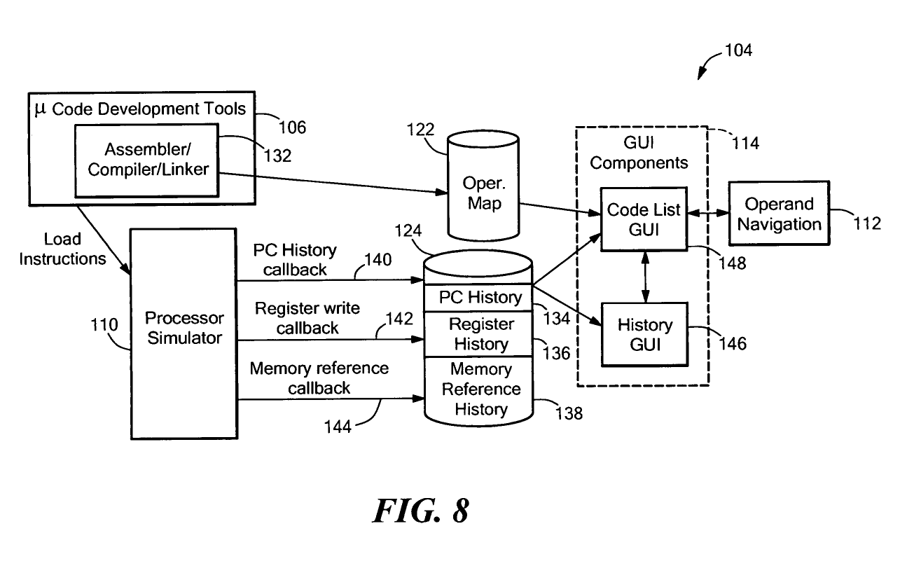

FIG. 8 shows a more detailed view of the various components of the application software 104 for the system of FIG. 7. They include an assembler and/or compiler, as well as linker 132; the processor simulator 110; the Event History 124; the (Instruction) Operation Map 126; GUI components 114; and the Operand Navigation process 112. The Event History 124 includes a Thread (Context)/PC History 134, a Register History 136 and a Memory Reference History 138. These histories, as well as the Operand Map 122, exist for every PE 20 in the processor 12.

The assembler and/or compiler produce the Operand Map 122 and, along with a linker, provide the microcode instructions to the processor simulator 110 for simulation. During simulation, the processor simulator 110 provides event notifications in the form of callbacks to the Event History 124. The callbacks include a PC History callback 140, a register write callback 142 and a memory reference callback 144. In response to the callbacks, that is, for each time event, the processor simulator can be queried for PE state information updates to be added to the Event History. The PE state information includes register and memory values, as well as PC values. Other information may be included as well.

Collectively, the databases of the Event History 124 and the Operand Map 122 provide enough information for the Operand Navigation 112 to follow register source-destination dependencies backward and forward through the PE microcode.

The system 102 of FIG. 7 can automatically generate evaluation code to examine performance on target hardware. The task 300 of FIG. 5 can provide an example for which code can be automatically generated.

FIG. 9 shows an exemplary evaluation code listing 420 for Initialize Parameters code block 304 of FIG. 5 as defined in FIG. 5A that can be automatically generated. The code block 420 initializes the parameters for packet processing. The code block 420 executes a NOP instruction 20 times as can be seen by the repeat instruction. In this case, the programmer estimates twenty NOPs as an equivalent processing load for the expected actual parameter initialization code to be developed later. The size of the code block, e.g., 20 NOPs, corresponds, for example, to the size input by the user when defining the code block as shown in FIG. 5A.

FIG. 10 shows an exemplary evaluation code listing 450 for I/O block 306 in FIG. 5 as defined in FIG. 5B. The listing 450 reads context information for a packet from an SRAM channel. The instructions below:

immed[addr_reg, (SRAM_CH_0_BASEADDR & 0xFFFF)]
immed_w1[addr_reg, ((SRAM_CH_0_BASEADDR >> 16) &
0xFFFF)]

load the 32-bit value corresponding to the symbolic name SRAM_CH_{—}0_BASEADDR (as defined by the user in the source/destination field 343 of FIG. 5B) into the 32-bit register called addr_reg. SRAM_SH_{—}0_BASEADDR represents the base address for SRAM Channel 0 memory. Two instructions are needed as each instruction loads 16 bits into the addr_reg register. The “immed” instruction loads the least significant 16 bits of SRAM_CH_{—}0_BASEADDR to the least significant 16 bits of register addr_reg. The “immed_w1” insruction loads the least significant 16 bits of its second operand to the most significant 16 bits of addr_reg. The second operand in the second instance is SRAM_CH_{—}0_BASEADDR with its bits shifted to the right by 16 bits, resulting in its least significant 16 bits being replaced by its most significant 16 bits.

The next instruction:
sram[read, $sreg0, addr_reg, 0, 8], sig_done[ioref]
   moves data between an PE and SRAM memory. In this case a read is performed, meaning the data is moved from SRAM memory to the PE. The term “$sreg0” refers to the name of the SRAM transfer register to which the data is to be read. Addr_reg is the SRAM address (offset by the following operand, which is 0 in this case) from which the data is read. The final operand (8) is the size of the data to be transferred in 4-byte words, meaning 32 bytes of data are transferred in the above example. The term “sig_done” is an optional token that follows an I/O reference instruction, such as an SRAM instruction, which indicates that the given signal (ioref in this case) is to be generated once the operation has been completed.

The next instruction
ctx_arb[ioref]
   performs a context swap and indicates that the ioref signal must be received before the current thread can be scheduled to execute.

The block of code described above performs the work of doing an I/O reference as configured in the architecture tool. The actual data that is loaded does not matter. It should, however, consume the correct amount of resources for the configured operation. The above instructions for the evaluation code will consume the correct amount of internal and external bus bandwidth and have the correct latency to examine performance of the later-developed functional code.

While particular code listings for code blocks, I/O references and NN references are shown, it is understood that the user can select a variety of code listings that can be automatically generated to meet the requirements of a particular application.

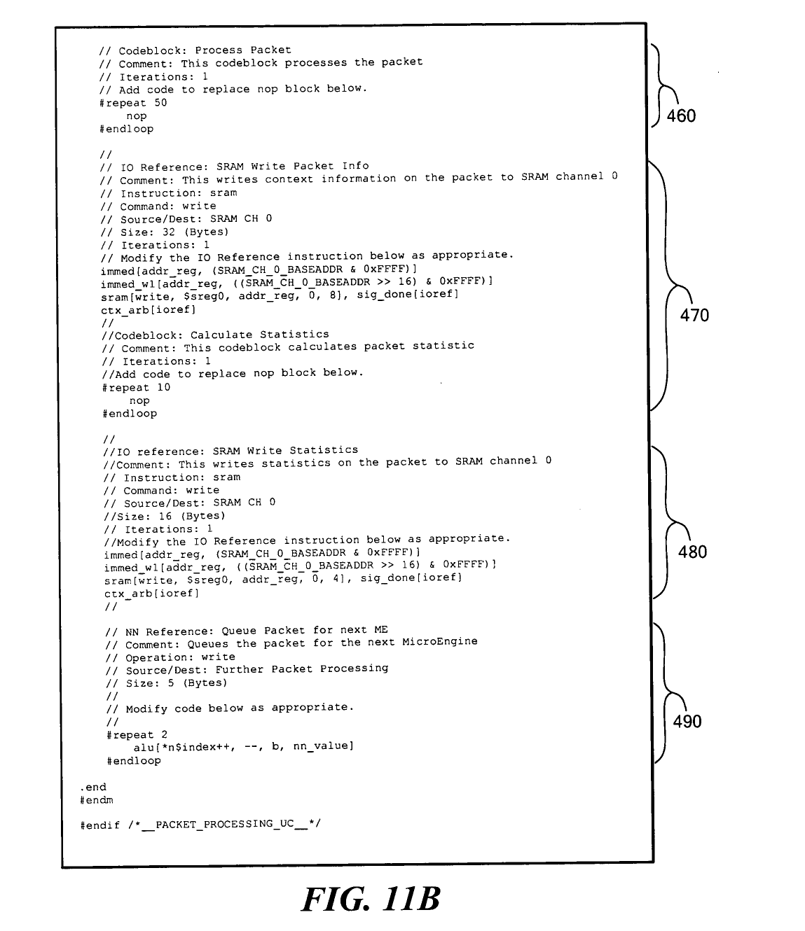

FIGS. 11A and 11B show a listing 500 of automatically generated code for the task 300 of FIG. 5. The listing 500 for the packet processing task 300 includes some optional comments and some naming of resources followed by the initialize parameters code block 420 of FIG. 9 and SRAM read packet info I/O reference 450 of FIG. 10. The listing 500 further includes code segments corresponding to the blocks of FIG. 5, including a code listing 460 for the process packet code block 308, a code listing 470 for the SRAM write packet info I/O reference 314, a code listing 480 for the SRAM write statistics I/O block 312, and a code listing 490 for the queue packet for the next PE next neighbor block 316.

To automatically generate the code listings, the task 300 in FIG. 5 is topologically sorted to generate a sequential set of code blocks, IO references and NN references. Then the code for each element is generated and output in the resulting order. The code generated for the code blocks is relatively straightforward. A repeat block of NOPs for the number of instructions configured by the user of the architecture tool.

The code generated for the I/O references depends on the instruction, command, size, and other attributes of the I/O reference as configured by the user of the architecture tool in FIG. 5B for example The generated code first loads the address of the I/O operation to a local PE register, then invokes the instruction to perform the IO operation, which could involve SRAM, DRAM, scratch, etc., as configured by the user. The operands of the particular instruction vary for each type of instruction and are populated accordingly using the configured parameters where appropriate. Where the instruction supports generating a signal, the optional sig_done[ioref] token is appended to the end of the instruction and the ctx_ar⁶[ioref] instruction is invoked to put the thread to sleep pending the signal.

The code for the NN reference, as in 490 uses the size configured for the reference. NN references are performed by writing to the NN registers which reside on the PE. The “alu” instruction shown operates on one or two source operands and deposits the result into the destination register. NN registers are indicated by using the *n$ prefix before the register name as in *n$index++. The ++ at the end is a post-increment operation so that following the alu instruction, the index refers to the next highest register. The alu command effectively writes a dummy value to the NN register. The alu instruction is repeated twice in this instance as the size of the reference is 5 bytes. The alu instruction writes four bytes (32-bits) at a time, so two instructions are needed to transfer five to eight bytes.

In an exemplary embodiment, the code for a processing element is written as a dispatch loop, which is microcode calling the relevant task macros in the prescribed order for each allocated thread. For each functional pipeline set, each associated task macro is called within the dispatch loop in order. Each task, e.g., .uc file, is included and the initialization macro called prior to entry into the dispatch loop. For each context pipeline, there is logic within the dispatch loop to determine which thread the code is executing and in turn call the appropriate task macro.

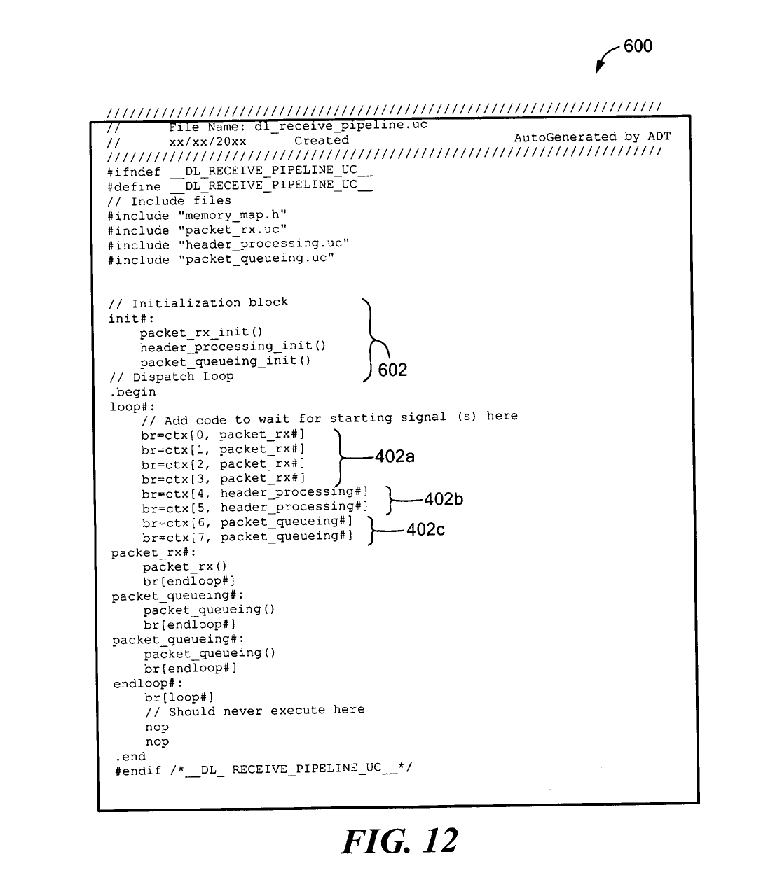

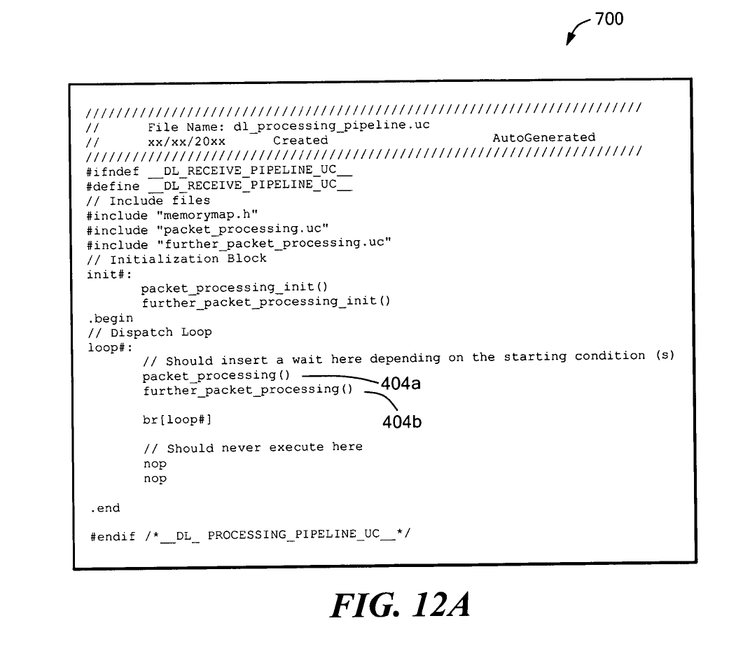

FIG. 12 shows an exemplary code listing 600 for a dispatch loop for the receive pipeline 402 context pipeline of FIG. 6. Dispatch loops for context pipelines are well known to one of ordinary skill in the art.

The dispatch loop 600 includes an initialization block 602 to initialize each of the pipeline tasks. The loop branches to the instruction at the specified label (packet_rx, header_processing, or packet_queuing) based on whether or not the current context is the specified context number. Based upon the current context, the tasks 402a-c in the receive packet pipeline 402 are performed.

FIG. 12A shows an exempalry code listing 700 of a dispatch loop for the functional processing pipeline 404 of FIG. 6 that executes the packet processing task 404a and then the further processing task 404b.

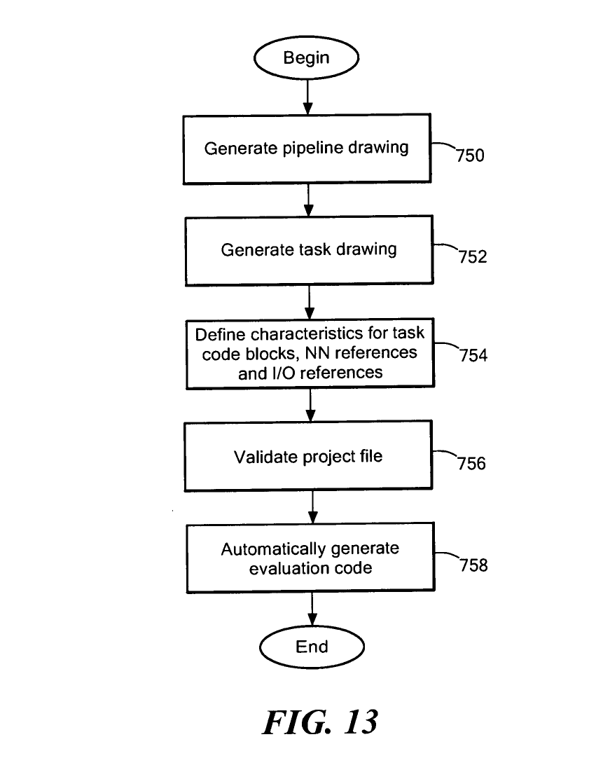

FIG. 13 shows an exemplary process to implement automatic generation of evaluation code for target hardware based upon a visual representation of an application. An architecture development tool can be used to generate a file for a project comprising processing pipelines, task, data streams, etc. In process block 750, a user generates a visual representation, such as that shown in FIG. 6, of a pipeline for target hardware. In one particular embodiment, the target hardware is a network processing unit containing multiple processors capable of running multiple processing threads. In processing block 752, the user generates a task drawing, such as the task 300 of FIG. 5, having a series of task segments such as code blocks, I/O references, and/or NN references, and the like. The user can define various characteristics of these task segments, such as size, iterations, source/destination, etc.

The project file defining a visual representation of the pipeline can be validated in processing block 756. In processing block 758, a development/debugger system can receive the validated project file and generate code for the project. The development system can automatically generate evaluation code for the tasks that can be used to examine expected performance against various parameters.

By automatically generating evaluation code to examine performance of a design in target hardware, there can be a rapid transition design to initial working code. Using an architecture visualization tool to describe an application for a network processor is more intuitive than some other approaches. The generated code provides similar performance as actual code to allow a developer to perform testing and tuning more rapidly than building projects manually. Because the evaluation code is generated automatically, it is less prone to errors since bugs are found and corrected within the code generation tool as opposed to each time a developer generates a new project.

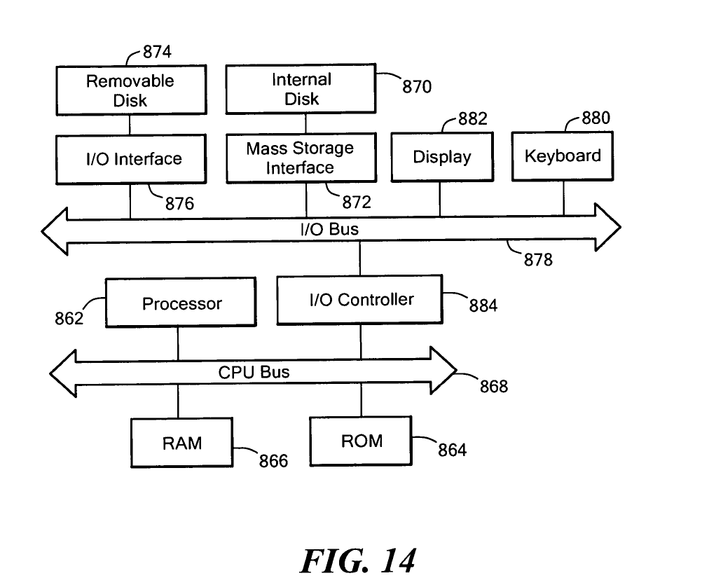

Referring to FIG. 14, an exemplary computer system 860 suitable for use as an assembler and/or a system 102 as a development/debugger system having an assembler supporting pseudo instructions/registers is shown. The assembler may be implemented in a computer program product tangibly embodied in a machine-readable storage device for execution by a computer processor 862; and methods may be performed by the computer processor 862 executing a program to perform functions of the tool by operating on input data and generating output.

Suitable processors include, by way of example, both general and special purpose microprocessors. Generally, the processor 862 will receive instructions and data from a read-only memory (ROM) 864 and/or a random access memory (RAM) 866 through a CPU bus 868. A computer can generally also receive programs and data from a storage medium such as an internal disk 870 operating through a mass storage interface 872 or a removable disk 874 operating through an I/O interface 876. The flow of data over an I/O bus 878 to and from devices 870, 874, (as well as input device 880, and output device 882) and the processor 862 and memory 866, 864 is controlled by an I/O controller 884. User input is obtained through the input device 880, which can be a keyboard, mouse, stylus, microphone, trackball, touch-sensitive screen, or other input device. These elements will be found in a conventional desktop computer as well as other computers suitable for executing computer programs implementing the methods described here, which may be used in conjunction with output device 882, which can be any display device (as shown), or other raster output device capable of producing color or gray scale pixels on paper, film, display screen, or other output medium.

Storage devices suitable for tangibly embodying computer program instructions include all forms of non-volatile memory, including by way of example semiconductor memory devices, such as EPROM, EEPROM, and flash memory devices; magnetic disks such as internal hard disks 870 and removable disks 874; magneto-optical disks; and CD-ROM disks. Any of the foregoing may be supplemented by, or incorporated in, specially-designed ASICs (application-specific integrated circuits).

Typically, processes reside on the internal disk 874. These processes are executed by the processor 862 in response to a user request to the computer system's operating system in the lower-level software 105 after being loaded into memory. Any files or records produced by these processes may be retrieved from a mass storage device such as the internal disk 870 or other local memory, such as RAM 866 or ROM 864.

The system 102 illustrates a system configuration in which the application software 104 is installed on a single stand-alone or networked computer system for local user access. In an alternative configuration, e.g., the software or portions of the software may be installed on a file server to which the system 102 is connected by a network, and the user of the system accesses the software over the network.

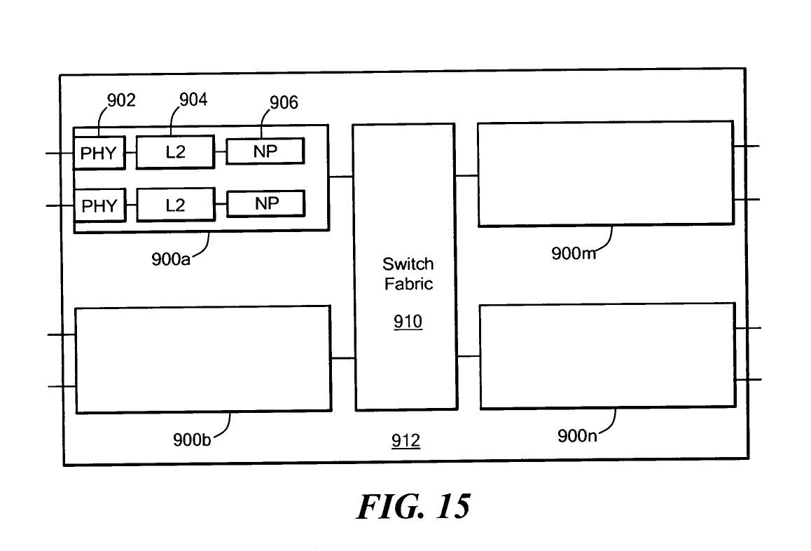

FIG. 15 depicts a network forwarding device that can include a network processor having microcode produced by an assembler supporting pseudo instructions/registers to resolve return address ambiguities. As shown, the device features a collection of line cards 900 (“blades”) interconnected by a switch fabric 910 (e.g., a crossbar or shared memory switch fabric). The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., 900a) may include one or more physical layer (PHY) devices 902 (e.g., optic, wire, and wireless PHYs) that handle communication over network connections. The PHYs translate between the physical signals carried by different network mediums and the bits (e.g., “0”-s and “1”-s) used by digital systems. The line cards 900 may also include framer devices (e.g., Ethernet, Synchronous Optic Network (SONET), High-Level Data Link (HDLC) framers or other “layer 2” devices) 904 that can perform operations on frames such as error detection and/or correction. The line cards 900 shown may also include one or more network processors 906 that perform packet processing operations for packets received via the PHY(s) 902 and direct the packets, via the switch fabric 910, to a line card providing an egress interface to forward the packet. Potentially, the network processor(s) 906 may perform “layer 2” duties instead of the framer devices 904.

While FIGS. 1, 2, 3 and 15 describe specific examples of a network processor and a device incorporating network processors, the code generation techniques described herein may be implemented in a variety of circuitry and architectures including network processors and network devices having designs other than those shown. Additionally, the techniques may be used in a wide variety of network devices (e.g., a router, switch, bridge, hub, traffic generator, and so forth).

The term circuitry as used herein includes hardwired circuitry, digital circuitry, analog circuitry, programmable circuitry, and so forth. The programmable circuitry may operate on computer programs.

Other embodiments are within the scope of the following claims.

1. A method to automatically generate evaluation code for target hardware, comprising:
receiving a visual definition of a data processing pipeline;
receiving a visual definition of a task that is part of the pipeline including segments of the task;
receiving characteristics of the task segments;
automatically generating code for one or more processing elements based upon the visual definition of the task and the task characteristics.

2. The method according to claim 1, wherein the task segments include at least one of code blocks, I/O references, and next neighbor references.

3. The method according to claim 1, wherein the task has multiple threads.

4. The method according to claim 1, wherein the task characteristics include at least one of size, number of iterations, and source destination.

5. The method according to claim 1, wherein the pipeline is provided as a first one of a context pipeline and a functional pipeline.

6. The method according to claim 1, wherein the task segments include an I/O reference with characteristics of at least one of data source/destination, read/write, transfer size, and number of iterations.

7. The method according to claim 1, further including receiving a project file for the visual representation of the pipeline and generating code automatically from the project file.

8. The method according to claim 7, wherein the project file is generated by an architecture development tool and the code is automatically generated by a code development system.

9. The method according to claim 1, wherein the target hardware includes a network processor having a plurality of processing elements.

10. The method according to claim 1, further including generating a graphical user interface to receive the characteristics of the code block, I/O reference, and/or NN reference.

11. The method according to claim 10, wherein the graphical user interface includes at least one of a size field, an iteration field, an instruction type field, and a data source/destination field.

12. The method according to claim 10, wherein the size field defines a number of NOP instructions for a code block.

13. The method according to claim 1, further including automatically generating the evaluation code to match expected performance characteristics of functional code.

14. The method according to claim 13, further including examining the evaluation code against performance requirements.

15. The method according to claim 1, further including automatically generating the evaluation code to include I/O operations having performance characteristics matching expected functional I/O references.

16. An article comprising:
a storage medium having stored thereon instructions that when executed by a machine result in the following:
receiving a visual definition of a data processing pipeline;
receiving a visual definition of a task that is part of the pipeline including segments of the task;
receiving characteristics of the task segments;
automatically generating code for one or more processing elements based upon the visual definition of the task and the task characteristics.

17. The article according to claim 16, wherein the task segments include at least one of code blocks, I/O references, and next neighbor references.

18. The article according to claim 16, wherein the task has multiple threads.

19. The article according to claim 16, wherein the task characteristics include at least one of size, number of iterations, and source destination.

20. The article according to claim 16, wherein the task segments include an I/O reference with characteristics of at least one of data source/destination, read/write, transfer size, and iterations.

21. The according to claim 16, wherein the target hardware includes a network processor having a plurality of processing elements.

22. The article according to claim 16, further including instructions to generate a graphical user interface to receive the characteristics of the code block, I/O reference, and/or NN reference.

23. The article according to claim 22, wherein the graphical user interface includes at least one of a size field, an iteration field, an instruction type field, and a data source/destination field.

24. The article according to claim 23, wherein the size field defines a number of NOP instructions for a code block.

25. A graphical user interface, comprising:
a window to show a visual representation of one or more of a data processing pipeline and a visual definition of a task that is part of the pipeline including segments of the task, and
a window to receive characteristics of the task segments, wherein the characteristics and the visual representation of the data processing pipeline and the task can be used to automatically generate code for one or more processing elements based upon the visual definition of the task and the task characteristics.

26. The graphical user interface according to claim 25, wherein the task segments include at least one of code blocks, I/O references, and next neighbor references.

27. The graphical user interface according to claim 25, wherein the task characteristics include at least one of size, number of iterations, and source destination.

28. The graphical user interface according to claim 25, wherein the task segments include an I/O reference with characteristics of at least one of data source/destination, read/write, transfer size, and iterations.

29. The graphical user interface according to claim 25, wherein the size field defines a number of NOP instructions for a code block.

30. A system, comprising:
an architecture development tool to visually represent a data processing pipeline including a visual representation of a task that is part of the pipeline including segments of the task, the task segments having characteristics specified by a user; and
a software development tool to automatically generate code for one or more processing elements based upon the visual representation of the task and the task characteristics.

31. The system according to claim 30, wherein the task segments include at least one of code blocks, I/O references, and next neighbor references.

32. The system according to claim 30, wherein the task characteristics include at least one of size, number of iterations, and source destination.

33. A network forwarding device, comprising:
at least one line card to forward data to ports of a switching fabric;
the at least one line card including a network processor having multi-threaded microengines configured to execute microcode, wherein the microcode comprises a microcode developed using an system that received a visual definition of a data processing pipeline;
received a visual definition of a task that is part of the pipeline including segments of the task;
received characteristics of the task segments; and
automatically generated code for one or more processing elements based upon the visual definition of the task and the task characteristics.

34. The device according to claim 33, wherein the task segments include at least one of code blocks, I/O references, and next neighbor references.

35. The device according to claim 34, wherein the task characteristics include at least one of size, number of iterations, and source destination.
